(19) United States
(12) Patent Application Publication
(10) Pub. No.: US 2020/0259339 A1
(43) Pub. Date: Aug. 13, 2020

(54) METHOD AND APPARATUS TO POWER AN ULTRA-LOW VOLTAGE TOW LIGHT ASSEMBLY AT A HIGH-SPEED CHARGING RATE

(71) Applicants: Elbert Leroy Young Jr., Beebe, AR (US); William Bryan Anderson, Rogers, AR (US)

(72) Inventors: Elbert Leroy Young Jr., Beebe, AR (US); William Bryan Anderson, Rogers, AR (US)

(21) Appl. No.: 16/273,161

(22) Filed: Feb. 12, 2019

(51) Int. Cl. H02J 7/00; H01G 11/10; H05B 37/02; H05B 33/08; B60Q 1/26

(52) U.S. Cl. CPC H02J 7/0014; H02J 7/007; H01G 11/10; H02J 2007/0067; H05B 33/0845; H02J 7/0063; B60Q 1/26; H05B 37/0254

(57) ABSTRACT

Disclosed are a method, a system and an apparatus to power an ultra-low voltage tow light assembly at a high-speed charging rate. In one embodiment, a tow light assembly includes a high power charging circuitry, a supercapacitor power bank, a microcontroller, an ultra-low voltage operating circuitry, an LED light bar, an LED lens, and an isolator unit. The high power charging circuitry coupled with the supercapacitor power bank fully charges the supercapacitor power bank instantaneously within few minutes. The microcontroller optimizes a wireless stop-tail-turn functionality of the tow light assembly at a minimal voltage. The ultra-low voltage operating circuitry operates the LED light bar at negligibly low voltage. The LED lens of the LED light bar operates at a low-set voltage. The isolator unit causes an automatic isolation of the supercapacitor power bank from the power source to prevent a potential short circuit and/or a power draw.

### FIELD OF TECHNOLOGY

This disclosure relates generally to a quick recharge energy storage device, and, more particularly, to a method, a system and an apparatus to power an ultra-low voltage tow light assembly at a high-speed charging rate.

### BACKGROUND

A taillight and/or tow light system may be a safety indicia used to provide stop, tail, turn light signal to an approaching traffic while driving. The taillight and/or tow light system may provide signal to a driver of an approaching vehicle while driving. The taillight and/or tow light system of a vehicle (e.g., a car, a utility vehicle, etc.), tow truck, and/or hauling equipment may be powered by a lead acid battery and/or a lithium-ion battery. The tow lights running on the lead acid battery and/or a lithium-ion battery may need to be frequently recharged to prevent them from discharging, making the tow lights inoperative. The frequent charging of the lead acid battery and/or a lithium-ion battery may deteriorate the energy storing capacity of these batteries overtime.

In addition. the lead acid battery and/or a lithium-ion battery may have a limited charging-discharging life cycle, and may need to be replaced after a particular life span. The lead acid battery and/or a lithium-ion battery of the tow lights may require longer time to recharge. Further, the lead acid battery and/or a lithium-ion battery may not hold their charge longer and may get discharged when not it use. Even further, the lead acid battery and/or a lithium-ion battery of the tow lights may be unable to power the tow lights at very low temperatures, making them unusable. Furthermore, the lead acid battery and/or a lithium-ion battery of the tow lights may pose an environmental threat if not disposed off in an appropriate manner.

### SUMMARY

Disclosed are a method, a system and an apparatus to power an ultra-low voltage tow light assembly at a high-speed charging rate.

In one aspect, a tow light assembly includes a high power charging circuitry, a supercapacitor power bank, a microcontroller, an ultra-low voltage operating circuitry, an LED light bar, an LED lens, and an isolator unit.

The high power charging circuitry coupled with a supercapacitor power bank charges the supercapacitor power bank from a power source at a charging rate that enables the tow light assembly to be fully charged instantaneously within few minutes. The microcontroller coupled with the high power charging circuitry optimizes a wireless stop-tail-turn functionality of the tow light assembly at a minimal voltage.

The ultra-low voltage operating circuitry connected to the supercapacitor power bank operates the LED light bar powered by the supercapacitor power bank at negligibly low voltage. The LED lens of the LED light bar operates at a low-set voltage to enable a runtime of the tow light assembly of at least 4-6 hours. The isolator unit coupled to the supercapacitor power bank causes an automatic isolation of the supercapacitor power bank from the power source to prevent a potential short circuit and/or a power draw.

A cell balancing circuitry coupled with the supercapacitor power bank may be configured to maintain the cell voltage of the supercapacitor power bank during a high-speed charging of the supercapacitor power bank. The isolator unit may prevent the supercapacitor power bank from discharging when the tow light assembly is not in use. The supercapacitor power bank may provide a number of charging-discharging life cycle of the supercapacitor power bank without causing damage to the supercapacitor power bank. A functional capacity of the supercapacitor power bank may remain unaltered even when fully discharged.

The tow light assembly may remain operative in low temperature environment upto minus 40 degrees fahrenheit. The supercapacitor power bank may include a plurality of the supercapacitors to charge at an optimum charging rate. The supercapacitor power bank may enable the tow light assembly to be fully charged instantaneously in less than 8 minutes. The ultra-low voltage operating circuitry may include a set of low voltage drivers to operate the LED light bar at a voltage less than 1 volt.

In another aspect, a system includes a supercapacitor power bank coupled with an LED light assembly to power the LED light assembly of a tow light enclosure. In addition, the system includes a high power charging circuitry coupled with the supercapacitor power bank to instantaneously charge the supercapacitor power bank from a power source at a high-speed charging rate to fully charge the LED light assembly of the tow light enclosure.

The system further includes a microcontroller coupled with the high power charging circuitry to optimize the wireless stop-tail-turn functionality of the tow light enclosure at a minimal voltage and control the high power charging circuitry of the supercapacitor power bank to fully charge the LED light assembly of the tow light enclosure instantaneously. Furthermore, the system includes an ultra-low voltage operating circuitry connected to the supercapacitor power bank to operate the LED light assembly powered by the supercapacitor bank at minimally low voltage. The ultra-low voltage operating circuitry operates the LED light assembly upto a complete drain-out capacity of the supercapacitor power bank.

Even further, the system includes an LED lens to run at a low-set voltage to maximize the runtime of the tow light enclosure. Additionally, an isolator unit coupled with the supercapacitor power bank causes automatic isolation of the supercapacitor power bank from the power source to prevent a potential short circuit and/or power draw.

In yet another aspect, a method includes charging a supercapacitor power bank of a tow light enclosure from a power source at a high-speed charging rate to fully charge the supercapacitor power bank within a reasonably short duration of time. The method includes powering the LED light assembly from the supercapacitor power bank. The method further includes optimizing a wireless stop-tail-turn functionality of the tow light enclosure at a minimal voltage. In addition, the method includes controlling the high power charging circuitry using a microcontroller and operating the LED light assembly at an ultra-low voltage.

Furthermore, the method includes maximizing a runtime of the tow light enclosure by operating the LED lens of the LED light assembly at a low-set voltage and automatically isolating the supercapacitor bank from the power source to prevent a potential short circuit and/or power draw.

The method may include integrating a set of low voltage drivers in the ultra-low voltage operating circuitry connected to the supercapacitor power bank to operate the LED light bar at a voltage less than 1 volt.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a block diagram illustrating an overview of a tow light assembly to operate an LED light assembly at an ultra-low voltage, according to one embodiment.

FIG. 2 is an exploded view of the tow light assembly of FIG. 1, according to one embodiment.

FIG. 3 is an apparatus view of the tow light assembly of FIG. 1, according to one embodiment.

FIG. 4 is a process flow illustrating the steps involved in optimization of a wireless stop-tail-turn functionality of the tow light assembly of FIG. 1 at a minimal voltage, according to one embodiment.

Other features of the present embodiments will be apparent from the accompanying drawings and from the detailed description that follows.

### DETAILED DESCRIPTION

Example embodiments, as described below, may be used to provide a method, a system and an apparatus to power an ultra-low voltage tow light assembly at a high-speed charging rate.

In one embodiment, a tow light assembly 100 includes a high power charging circuitry 102, a supercapacitor power bank 104, a microcontroller 106, an ultra-low voltage operating circuitry 108, an LED light bar (e.g., LED light assembly 110), an LED lens, and an isolator unit 114.

The high power charging circuitry 102 coupled with a supercapacitor power bank 104 charges the supercapacitor power bank 104 from a power source at a charging rate that enables the tow light assembly 100 to be fully charged instantaneously within few minutes. The microcontroller 106 coupled with the high power charging circuitry 102 optimizes a wireless stop-tail-turn functionality of the tow light assembly 100 at a minimal voltage. It should be understood that the term “circuitry” as used in this case may be components of an electrical circuit, a detailed plan of an integrated circuit, a set of different components operating together, and/or a combination of hardware, firmware, and/or software modules operating in unison to perform a particular function.

The ultra-low voltage operating circuitry 108 connected to the supercapacitor power bank 104 operates the LED light bar (e.g., LED light assembly 110) powered by the supercapacitor power bank 104 at negligibly low voltage. The LED lens of the LED light bar (e.g., LED light assembly 110) operates at a low-set voltage to enable a runtime of the tow light assembly 100 of at least a 4-6 hour period. The isolator unit 114 coupled to the supercapacitor power bank 104 causes an automatic isolation of the supercapacitor power bank 104 from the power source to prevent a potential short circuit and/or a power draw.

A cell balancing circuitry 202 coupled to the supercapacitor power bank 104 may be configured to maintain the cell voltage of the supercapacitor power bank 104 during a high-speed charging of the supercapacitor power bank 104. The isolator unit 114 may prevent the supercapacitor power bank 104 from discharging when the tow light assembly 100 is not in use. The supercapacitor power bank 104 may provide a number of charging-discharging life cycle of the supercapacitor power bank 104 without causing damage to the supercapacitor power bank 104. A functional capacity of the supercapacitor power bank 104 may remain unaltered even when fully discharged.

The tow light assembly 100 may remain operative in low temperature environment upto −40 degrees fahrenheit. The supercapacitor power bank 104 may include a plurality of the supercapacitors to charge at an optimum charging rate. The supercapacitor power bank may enable the tow light assembly to be fully charged instantaneously in less than 8 minutes. The ultra-low voltage operating circuitry 108 may include a set of low voltage drivers to operate the LED light bar (e.g., LED light assembly 110) at a voltage less than 1 volt.

In another embodiment, a system includes a supercapacitor power bank 104 coupled with an LED light assembly 110 to power the LED light assembly 110 of a tow light enclosure (e.g., tow light assembly 100). The system further includes a high power charging circuitry 102 coupled with the supercapacitor power bank 104 to instantaneously charge the supercapacitor power bank 104 from a power source at a high-speed charging rate to fully charge the LED light assembly 110 of the tow light enclosure.

In addition, the system includes a microcontroller 106 coupled with the high power charging circuitry 102 to optimize the wireless stop-tail-turn functionality of the tow light enclosure (e.g., tow light assembly 100) at a minimal voltage and control the high power charging circuitry 102 of the supercapacitor power bank 104 to fully charge the LED light assembly 110 of the tow light enclosure (e.g., tow light assembly 100) instantaneously. Furthermore, the system includes an ultra-low voltage operating circuitry 108 connected to the supercapacitor power bank 104 to operate the LED light assembly 110 powered by the supercapacitor power bank 104 at minimally low voltage. The ultra-low voltage operating circuitry 108 operates the LED light assembly 110 upto complete drain-out capacity of the supercapacitor power bank 104.

Even further, the system includes an LED lens 112 to run at a low-set voltage to maximize the runtime of the tow light enclosure (e.g., tow light assembly 100). Additionally, an isolator unit 114 coupled with the supercapacitor power bank 104 causes automatic isolation of the supercapacitor power bank 104 from the power source to prevent a potential short circuit and/or power draw.

In yet another embodiment, a method includes charging a supercapacitor power bank 104 of a tow light enclosure (e.g., tow light assembly 100) from a power source at a high-speed charging rate to fully charge the supercapacitor power bank 104 within a reasonably short duration of time. The method includes powering the LED light assembly 110 from the supercapacitor power bank 104. The method further includes optimizing a wireless stop-tail-turn functionality of the tow light enclosure (e.g., tow light assembly 100) at a minimal voltage. In addition, the method includes controlling the high power charging circuitry 102 using a microcontroller 106 and operating the LED light assembly 110 at an ultra-low voltage.

Furthermore, the method includes maximizing a runtime of the tow light enclosure (e.g., tow light assembly 100) by operating the LED lens of the LED light assembly 110 at a low-set voltage and automatically isolating the supercapacitor power bank 104 from the power source to prevent a potential short circuit and/or power draw.

The method may include configuring a cell balancing circuitry coupled to the supercapacitor power bank 104 to maintain the cell voltage of the supercapacitor power bank 104 during a high-speed charging of the supercapacitor power bank 104. The high-speed charging rate of the supercapacitor power bank 104 enables the tow light enclosure (e.g., tow light assembly 100) to be fully charged in less than 8 minutes. The method may further include integrating a set of low voltage drivers in the ultra-low voltage operating circuitry 108 connected to the supercapacitor power bank 104 to operate the LED light bar (e.g., LED light assembly 110) at a voltage less than 1 volt.

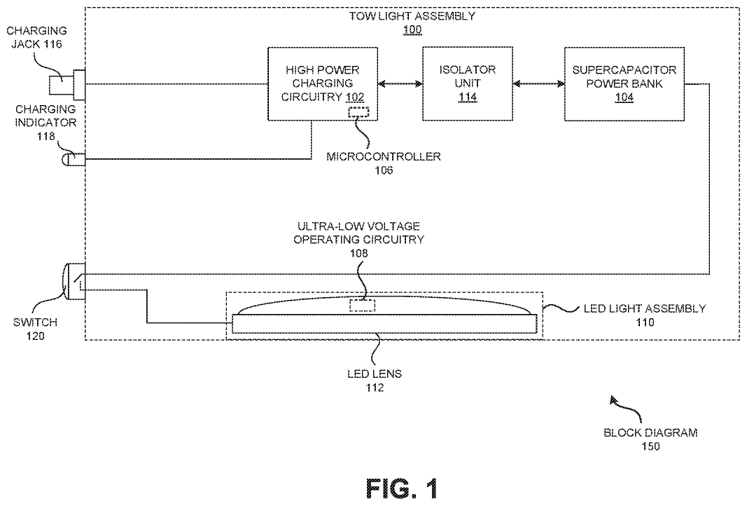

FIG. 1 is a block diagram 150 illustrating an overview of a tow light assembly 100 to operate an LED light assembly 110 at an ultra-low voltage, according to one embodiment. Particularly, FIG. 1 illustrates the tow light assembly 100, a high power charging circuitry 102, a supercapacitor power bank 104, a microcontroller 106, an ultra-low voltage operating circuitry 108, an LED light assembly 110, an LED lens 112, an isolator unit 114, a charging jack 116, a charging indicator 118, and a switch 120, according to one embodiment.

The tow light assembly 100 may be an assemblage of warning lights mounted at the rear of a vehicle to provide warning signal to the traffic and/or a vehicle coming from behind. The tow light assembly 100 may include stop-tail-turn light, strobe lights and Department of Transportation (D.O.T.) lights housed in a heavy duty PVC enclosure (e.g., housing 302) to enable a driver to indicate direction of travel, and his intentions regarding direction and speed of travel. The tow light assembly 100 may include a high power charging circuitry 102, a supercapacitor power bank 104, a microcontroller 106, an ultra-low voltage operating circuitry 108, an LED light assembly 110, and an isolator unit 114 enclosed in a housing 302 to operate the stop, tail, turn lights functionality of the LED light assembly 110 at an ultra-low voltage, according to one embodiment.

The high power charging circuitry 102 may be a system of circuits designed to charge the supercapacitor power bank 104 of the tow light assembly 100 at a high-speed charging rate. The high power charging circuitry 102 may enable the supercapacitor power bank 104 of the tow light assembly 100 to be fully charged in less than 8 minutes when connected to the power source through the charging jack 116. The high power charging circuitry 102 may allow for a user to “quick charge” the tow light assembly 100 and return back to service within few minutes, according to one embodiment.

The supercapacitor power bank 104 may be an electrical circuitry comprising plurality of supercapacitors to control power flow in the tow light assembly 100. The supercapacitor power bank 104 may store electrical energy and then later use it to charge the LED light assembly 110 to operate the tow light assembly 100. The supercapacitor power bank 104 may contain necessary power capacity to operate the tow light assembly 100. The supercapacitor power bank 104 may provide a runtime of at least 4-5 hour when charged for at least 8 minutes. The supercapacitor power bank 104 may be charged up using a USB charger. The supercapacitor power bank 104 may include upto 6, 300 Farad capacitors connected in series and/or parallel configuration to generate a required capacitance to operate the tow light assembly 100, according to one embodiment.

The supercapacitor power bank 104 may be designed to provide charging and/or discharging life cycle of more than 100K without causing any damage to its functional capacity. Further, the functional capacity of supercapacitor power bank 104 may remain unaltered even when it is fully discharged to zero volts. The supercapacitor power bank 104 may not have a memory effect on its functional capacity. The supercapacitor power bank 104 may not cause any hazardous effect on the environment because of using lead-free supercapacitors in the circuitry. The supercapacitor power bank 104 may enable the tow light assembly 100 to operate in under voltage situations as well, according to one embodiment.

The microcontroller 106 may be a compact integrated circuit designed to govern a specific operation in the supercapacitor power bank 104 to operate the stop tail turn light functionality of the tow light assembly 100 wirelessly at a very low voltage. The microcontroller 106 may include a processor, a memory and input/output (I/O) peripherals on a single chip. The microcontroller 106 may be programmed to control the high power charging circuitry 102 of the supercapacitor power bank 104 to fully charge the LED light assembly instantaneously (e.g., in less than 8 minutes). The microcontroller 106 may be designed with sufficient onboard memory as well as offering pins for general I/O operations, and may directly interface with sensors and other components of the tow light assembly 100. The microcontroller 106 may further be programmed to trigger the isolator unit 114 to automatically isolate the supercapacitor power bank 104 from the power source to avoid any potential short circuit and/or power draw from the power source, according to one embodiment.

The ultra-low voltage operating circuitry 108 may be an electrical circuit system designed to run the LED light assembly 110 of the tow light assembly 100 at a minimally low voltage. The ultra-low voltage operating circuitry 108 may operate at an optimally low voltage in order to drain out as much capacity of the supercapacitor power bank 104 to operate the LED light assembly 110. The ultra-low voltage operating circuitry 108 may run down the minimum charge of less than 1 volt. The ultra-low voltage operating circuitry 108 may be designed to draw current from the supercapacitor power bank 104 until it is fully discharged, according to one embodiment.

The LED light assembly 110 may be a number of LED lights arranged together to operate the stop tail turn functionality of the tow light assembly 100. The LED light assembly 110 may include an LED lens 112 to protect the bulbs in the LED light assembly 110 and the ultra-low voltage operating circuitry 108 to operate the LED light assembly 110 at a very low voltage, according to one embodiment.

The LED lens 112 may be an LED module and/or strip comprising a number of LEDs in the tow light assembly 100 to create the desired lighting effect. The LED lens 112 may enable precise control over the beams of light. The LED lens 112 may protect the bulbs in the LED light assembly 110 that are fragile and exposure to the external elements may easily cause them to burn out and/or even crack, according to one embodiment.

The isolator unit 114 may be a device used for isolating the supercapacitor power bank 104 from a power source. The isolator unit 114 may be a mechanical switching device that, in the open position, allows for isolation of the input and output of the supercapacitor power bank 104. The isolator unit 114 may isolate the supercapacitor power bank 104 from the power source to prevent any short circuiting or power draw at the charging jack 116, according to one embodiment.

The charging jack 116 may be a physical connector that mates with another connector (e.g., a type of plug on the end of a cable) to electrically connects the supercapacitor power bank 104 to a power source. For example, a charging port may connect the tow light assembly 100 to a power source to recharge the supercapacitor power bank 104 of the tow light assembly 100, according to one embodiment.

The charging indicator 118 may be an LED light in the tow light assembly 100 to indicate the ON/OFF state and/or level of charging. A fast blinking of the charging indicator 118 may indicate charging of the tow light assembly 100 while a steady ON condition may indicate a fully charged status of the tow light assembly 100, according to one embodiment.

The switch 120 may be a device for making and/or breaking the connection in the LED light assembly 110. The switch 120 may disconnect the power supply to the LED lens 112 from the supercapacitor power bank 104. The switch 120 may provide isolation of the supercapacitor power bank 104 to prevent it from discharging when not in use, according to one embodiment.

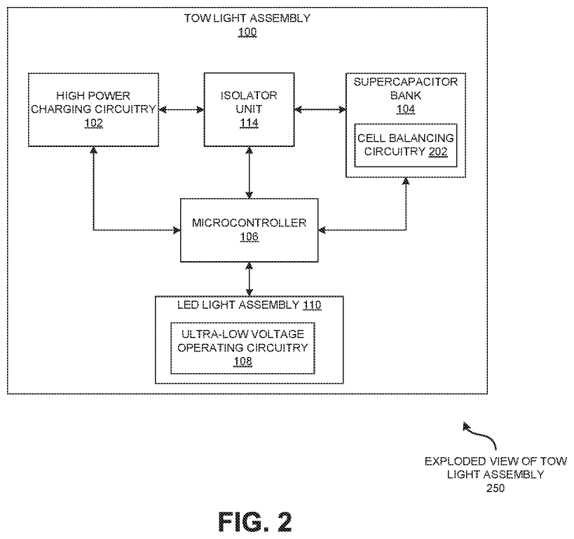

FIG. 2 is an exploded view 250 of the tow light assembly 100 of FIG. 1, according to one embodiment. Particularly, FIG. 2 builds on FIG. 1, and further includes a cell balancing circuitry 202, according to one embodiment.

The cell balancing circuitry 202 may be a circuitry designed to maximize the capacity of the supercapacitor power bank 104 with multiple supercapacitors (e.g., in series configuration) to make all of the capacity available for use and increase each supercapacitor's longevity. The cell balancing circuitry 202 may be a device in the supercapacitor power bank 104 that performs battery balancing of the supercapacitor power bank 104 during a high-speed charging of the supercapacitor power bank 104. The cell balancing circuitry 202 may be designed to ensure that the cell voltages are maintained in the supercapacitor power bank 104 during quick charging of the supercapacitor power bank 104. The cell balancing circuitry 202 may protect the supercapacitor power bank 104 from overvoltage and/or undervoltage stress, according to one embodiment.

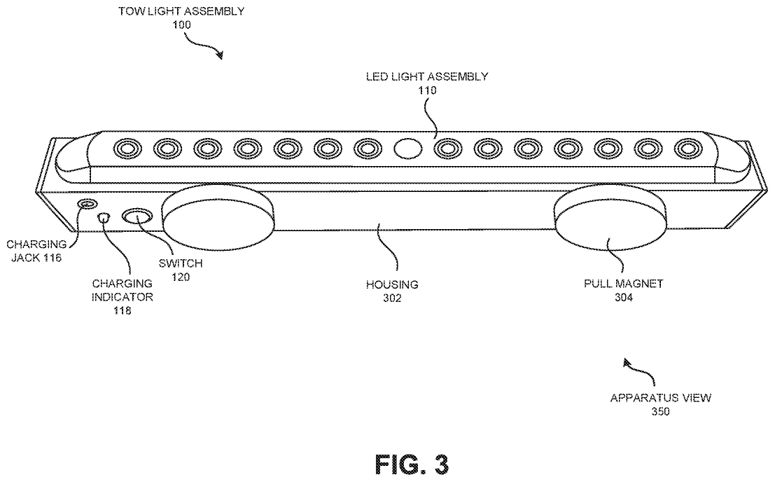

FIG. 3 is an apparatus view 350 of the tow light assembly 100 of FIG. 1, according to one embodiment. Particularly FIG. 3 builds on FIGS. 1 and 2, and further includes, a housing 302 and a pull magnet 304, according to one embodiment.

The housing 302 may be a rigid casing to enclose and/or protect the tow light assembly 100. The housing 302 may be a compact, light-weight enclosure to house the tow light assembly 100. The rigid casing of the housing 302 may protect the tow light assembly 100 from varying environmental conditions to remain operative in low temperature environment upto −40 degrees fahrenheit. The pull magnet 304 may be provided on the housing 302 of the tow light assembly 100 to help securely position the tow light assembly 100 at the rear of the vehicle while driving, according to one embodiment.

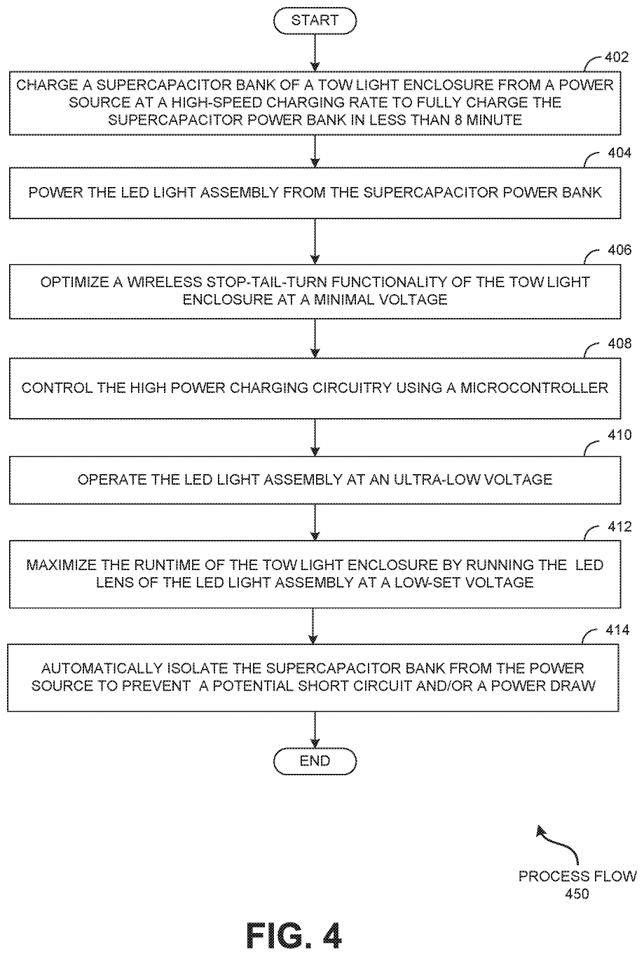

FIG. 4 is a process flow 450 illustrating the steps involved in optimization of a wireless stop-tail-turn functionality of the tow light assembly 100 of FIG. 1 at a minimal voltage, according to one embodiment.

In operation 402, a supercapacitor power bank 104 of a tow light enclosure (e.g., tow light assembly 100) may be charged from a power source at a high-speed charging rate to fully charge the supercapacitor power bank 104 in less than 8 minutes. In operation 404, the LED light assembly 110 may be powered from the supercapacitor power bank 104. In operation 406, a wireless stop-tail-turn functionality of the tow light enclosure (e.g., tow light assembly 100) may be optimized at a minimal voltage.

In operation 408, the high power charging circuitry 102 may be controlled using a microcontroller. In operation 410, the LED light assembly 110 may be operated at an ultra-low voltage. In operation 412, a runtime of the tow light enclosure (e.g., tow light assembly 100) may be maximized by operating the LED lens 112 of the LED light assembly 110 at a low-set voltage. In operation 414, the supercapacitor power bank 104 may be automatically isolated from the power source to prevent a potential short circuit and/or a power draw, according to one embodiment.

An example embodiment may now be described. Alex Doe may be working as a tow truck operator during night-time to support his college education in the New York City. In his job as a tow truck operator, Alex may require to pick up disabled vehicles from various parts of the New York City, including the five boroughs of New York City. On many occasions, the disabled vehicles that Alex may require to pick, may have missing taillights. In such situations, Alex may be required to use his own tow light unit on the back of the disabled vehicle to provide turn signals, brakes, and tail lights. Alex may be using a tow light unit in his tow truck to provide stop, tail, and turn light signal to an approaching traffic while driving.

The tow light unit used by Alex may be powered by a lead acid battery and/or a lithium-ion battery. The lead acid battery and/or a lithium-ion battery used to run the tow light unit may be discharging quickly while driving, making the tow lights inoperative. Alex may have faced accidental situations because of inoperative tow lights. Further, the tow lights running on the lead acid battery and/or a lithium-ion battery of his tow light unit may need to be frequently recharged to prevent them from discharging. The frequent charging of the lead acid battery and/or a lithium-ion battery may have deteriorated the energy storing capacity of these batteries overtime, requiring frequent replacement of batteries causing unwarranted expenditure.

To save his hard-earned money from frequent undesired expenditure, Alex may have replaced the tow light unit of his tow truck with the new tow light assembly 100 as described in various embodiments of FIGS. 1-4. Alex may now be able to recharge his new tow light assembly 100 very quickly within less than 8 minutes and may be ready quickly to drive his tow truck to pick up disabled vehicles from anywhere in the New York City. The new tow light assembly 100 installed by Alex, may have an extended runtime due to its ultra-low voltage operating circuitry 108 in its LED light bar, which may not require frequent recharging of his new tow light assembly 100, as described in various embodiments of FIGS. 1-4, saving his time.

Additionally, the isolator unit 114 in the new tow light assembly 100 may prevent his new tow light assembly 100 from discharging when not in use, as described in various embodiments of FIGS. 1-4, increasing its operating time. Furthermore, the supercapacitor power bank 104 of his new tow light assembly 100 may be lightweight, lead and halogen free making it a more environment friendly power source to illuminate his new tow light assembly 100, reducing his carbon footprint.

Although the present embodiments have been described with reference to specific example embodiments, it will be evident that various modifications and changes may be made to these embodiments without departing from the broader spirit and scope of the various embodiments. For example, the various electrical structure and methods may be embodied using transistors, logic gates, and electrical circuits (e.g., application specific integrated (ASIC) circuitry and/or Digital Signal Processor (DSP) circuitry).

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Moreover, the scope of the present application is not intended to be limited to the particular illustrative examples of the circuitry, process, machine, manufacture, and composition of matter, means, methods and steps incorporating the features of the present application that are described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding example arrangements described herein may be utilized according to the illustrative arrangements and alternative arrangements. Accordingly, the appended claims are intended to include within their scope such processes, machines, manufacture, compositions of matter, means, methods, or steps.

The tow light assembly 100 as described in various embodiments of FIGS. 1-4 may include various “circuitry(ies)” as used in this case. The circuitries used in the tow light assembly 100 as described in various embodiments of FIGS. 1-4 may be components of an electrical circuit, a detailed plan of an integrated circuit, a set of different components operating together, and/or a combination of hardware, firmware, and/or software modules operating in unison to perform a particular function.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to circuits and circuitry may be explained through block and flow diagrams of systems, methods, apparatuses, and/or computer program products according to various implementations. It will be understood that one or more circuits can be implemented by computer-executable program instructions. Likewise, some circuits of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, the circuits and block diagrams support combinations of means for performing the specified functions, combinations of elements or steps for performing the specified functions and program instruction means for performing the specified functions. It will also be understood that some circuits can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A tow light assembly comprising:
a high power charging circuitry coupled with a supercapacitor power bank to charge the supercapacitor power bank from a power source at a charging rate that enables the tow light assembly to be fully charged instantaneously within few minutes;
a microcontroller coupled with the high power charging circuitry to optimize a wireless stop-tail-turn functionality of the tow light assembly at a minimal voltage;
an ultra-low voltage operating circuitry connected to the supercapacitor power bank to operate an LED light bar powered by the supercapacitor power bank at negligibly low voltage;
an LED lens of the LED light bar to operate at a low-set voltage to enable a runtime of the tow light assembly of at least a 4-6 hour period; and
an isolator unit coupled to the supercapacitor power bank to cause automatic isolation of the supercapacitor power bank from the power source to prevent at least one of a potential short circuit and a power draw.

2. The tow light assembly of claim 1, wherein a cell balancing circuitry coupled with the supercapacitor power bank is configured to maintain the cell voltage of the supercapacitor power bank during a high-speed charging of the supercapacitor power bank.

3. The tow light assembly of claim 1, wherein the isolator unit to prevent the supercapacitor power bank from discharging when the tow light assembly is not in use.

4. The tow light assembly of claim 1, wherein,
the supercapacitor power bank to provide a number of charging-discharging life cycle of the supercapacitor power bank without causing damage to the supercapacitor power bank, and
a functional capacity of the supercapacitor power bank to remain unaltered even when fully discharged.

5. The tow light assembly of claim 1, wherein the tow light assembly to remain operative in low temperature environment upto a −40 degrees fahrenheit.

6. The tow light assembly of claim 1, wherein:
the supercapacitor power bank to include a plurality of the supercapacitors to charge at an optimum charging rate, and
the supercapacitor power bank to enable the tow light assembly to be fully charged instantaneously in less than 8 minutes.

7. The tow light assembly of claim 1, wherein the ultra-low voltage operating circuitry to include a set of low voltage drivers to operate the LED light bar at a voltage less than 1 volt.

8. A system comprising:
a supercapacitor power bank coupled with an LED light assembly to power the LED light assembly of a tow light enclosure;
a high power charging circuitry coupled with the supercapacitor power bank to instantaneously charge the supercapacitor power bank from a power source at a high-speed charging rate to fully charge the LED light assembly of the tow light enclosure;
a microcontroller coupled with the high power charging circuitry to:
optimize the wireless stop-tail-turn functionality of the tow light enclosure at a minimal voltage, and
control the high power charging circuitry of the supercapacitor power bank to fully charge the LED light assembly of the tow light enclosure instantaneously;
an ultra-low voltage operating circuitry connected to the supercapacitor power bank to operate the LED light assembly powered by the supercapacitor power bank at minimally low voltage,
wherein the ultra-low voltage operating circuitry to operate the LED light assembly upto a complete drain-out capacity of the supercapacitor power bank;
an LED lens to run at a low-set voltage to maximize the runtime of the tow light enclosure; and
an isolator unit coupled with the supercapacitor power bank to cause automatic isolation of the supercapacitor power bank from the power source to prevent at least one of a potential short circuit and a power draw.

9. The system of claim 8 further comprising:
a cell balancing circuitry coupled to the supercapacitor power bank configured to maintain the cell voltage of the supercapacitor power bank during a high-speed charging of the supercapacitor power bank.

10. The system of claim 8 further comprising:
the isolator unit to prevent the supercapacitor power bank from discharging when the tow light assembly is not in use.

11. The system of claim 8 further comprising:
the supercapacitor power bank to provide a number of charging-discharging life cycle of the supercapacitor power bank without causing damage to the supercapacitor power bank,
wherein the functional capacity of the supercapacitor power bank to remain unaltered even when fully discharged.

12. The system of claim 8 wherein, the tow light assembly to remain operative in low temperature environment upto −40 degrees fahrenheit.

13. The system of claim 8 wherein,
the supercapacitor power bank to include a plurality of the supercapacitors to charge at an optimum charging rate, and
the supercapacitor power bank to enable the tow light assembly to be fully charged instantaneously in less than 8 minutes.

14. The system of claim 8 wherein, the ultra-low voltage operating circuitry to include a set of low voltage drivers to operate the LED light bar at a voltage less than 1 volt.

15. A method comprising:
charging a supercapacitor power bank of a tow light enclosure from a power source at a high-speed charging rate to fully charge the supercapacitor power bank within a reasonably short duration of time;
powering the LED light assembly from the supercapacitor power bank;
optimizing a wireless stop-tail-turn functionality of the tow light enclosure at a minimal voltage;
controlling the high power charging circuitry using a microcontroller;
operating the LED light assembly at an ultra-low voltage;
maximizing a runtime of the tow light enclosure by operating the LED lens of the LED light assembly at a low-set voltage; and
automatically isolating the supercapacitor power bank from the power source to prevent at least one of a potential short circuit and a power draw.

16. The method of claim 15 further comprising:
configuring a cell balancing circuitry coupled to the supercapacitor power bank to maintain the cell voltage of the supercapacitor power bank during a high-speed charging of the supercapacitor power bank,
wherein the high-speed charging rate of the supercapacitor power bank enables the tow light enclosure to be fully charged in less than 8 minutes.

17. The method of claim 15 further comprising:
preventing the supercapacitor power bank from fully discharging when the tow light enclosure is not in use.

18. The method of claim 15 further comprising:
providing a number of charging-discharging life cycle of the supercapacitor power bank without causing damage to the supercapacitor power bank.

19. The method of claim 15 wherein:
the tow light enclosure to remain operative in low temperature environment upto −40 degrees fahrenheit.

20. The method of claim 15 further comprising:
integrating a set of low voltage drivers in the ultra-low voltage operating circuitry connected to the supercapacitor power bank to operate the LED light bar at a voltage less than 1 volt.
